(19) United States
(12) Patent Application Publication
(10) Pub. No.: US 2013/0208890 A1
(43) Pub. Date: Aug. 15, 2013

(54) KEY WITH REMOTE CONTROL, IN PARTICULAR FOR MOTOR VEHICLES, AND ARRANGEMENT WITH SUCH A KEY

(71) Applicant: Ludger Weghaus, Lippstadt (DE)

(72) Inventor: Ludger Weghaus, Lippstadt (DE)

(73) Assignee: HELLA KGaA, Lippstadt (DE)

(21) Appl. No.: 13/818,066

(22) PCT Filed: Aug. 19, 2011
(86) PCT No.: PCT/EP2011/064285

§ 371 Date: May 6, 2013

(30) Foreign Application Priority Data
Aug. 20, 2010 (DE) 10 2010 034 977.1

(51) Int. Cl. H04W 12/06

(52) U.S. Cl. CPC H04W 12/06
USPC 380/270

(57) ABSTRACT

A key with remote radio operation, particularly for motor vehicles, includes a housing and electronic circuits arranged in the housing for the purpose of authentication of the key, wherein each circuit has an interface for communication with an authenticating entity outside of the key. The problem addressed is that of structuring a key for use with nascent transmission standards. This problem is addressed in that a first circuit of the key has a BTLE interface, and a second circuit of the key has an NFC interface, for the purpose of communication.

### CROSS REFERENCE

This application claims priority to PCT Application No. PCT/EP2011/064285 filed Aug. 19, 2011, which in turn claims priority to German Patent Application No. 10 2010 034977.1, filed Aug. 20, 2010, both of which are expressly incorporated in its entirety by reference herein.

### TECHNICAL FIELD OF THE INVENTION

The invention relates to a key with remote radio operation, particularly for motor vehicles, having a housing and electronic circuits arranged in the housing for the purpose of authentication of the key, wherein each circuit has an interface for communication with an authenticating entity outside of the key.

### BACKGROUND OF THE INVENTION

Modern car keys are often radio keys which can be used to lock and unlock the doors both mechanically and by means of remote radio operation. The key is therefore a part of the control system by means of which it is possible to control access to the vehicle. In new vehicles, a transponder (e.g., an RFID chip) is usually integrated into the key, wherein the data thereof is necessary to unlock an anti-theft device. The key is therefore a part of the system to control driver authorization.

Both for the control of access authorization and for the control of driver authorization, it is necessary for an authenticating entity to provide authentication, wherein the key must authenticate itself to the authenticating entity. Only once a successful authentication determines the identity of the key is the user of the key authorized to access the vehicle or to drive.

The keys used to date and the arrangements consisting of these keys and motor vehicles have proven their usefulness many times over. The transmission protocols used for the communication between key and vehicle enable secure communication between the keys and the vehicles. However, the protocols used only enable a communication between the vehicle and the key. Communication with other entities is not possible.

In contrast, communication protocols are known from the field of so-called consumer electronics and other areas of the electronics field which are already used in a wide variety of ways, and it can be seen that they will also be widely used in the future.

By way of example, the NFC transmission standard is intended to enable the exchange of various types of information between two devices held near to each other, including telephone numbers, images, MP3 files, or digital authorizations, for example. The NFC transmission standard could also be used as an access key for contents and for services such as cashless payments, ticketing, online entertainment, and access control. The security functions required for these applications are integrated into a suitable hardware device. The NFC technology is based on the combination of a smartcard and wireless connection technologies. It works in a frequency range of 13.56 MHz, and offers a data transmission rate of at most 424 kBit/s with a range of only 10 cm.

A further, widely-used transmission standard is the Bluetooth variant BTLE, which can have ranges of up to 100 meters. Bluetooth low energy (BTLE) is a wireless radio technology by means of which devices can network to each other in a close link range. BTLE transmits in the 2.4 GHz range, but is intended to consume significantly less energy in the process, and to be significantly more cost-effective in its integration than conventional Bluetooth applications. Bluetooth low energy is offered as a single-chip solution for small devices. Corresponding integrated circuits have at least been announced by various providers.

Both transmission standards have specific advantages and disadvantages which speak for or against their use in the control of access authorization or driver authorization.

At the same time, each of the two transmission standards will likely offer the option in the future of communication between the vehicle, and particularly the key, and consumer electronics devices or other devices, in order to achieve an added value for the user. In addition, each of the two transmission standards offers the possibility, the same likely being multi-faceted, of utilizing standardized, cost-effective components.

### SUMMARY OF THE INVENTION

The present invention addresses the problem of structuring keys of the above type for use with nascent transmission standards.

This problem is addressed according to the invention in that a first circuit of the key according to the invention has a BTLE interface, and a second circuit of the key according to the invention has an NFC interface, for the purpose of communication.

The two circuits with the two different interfaces make the key a means which is useful beyond the functions of access authorization control and drive authorization control. In addition, the strengths of the different interfaces and the standards implemented by these interfaces can be played off each other.

The first circuit with the BTLE interface is capable of communicating via the BTLE transmission standard with authenticating entities at distances of up to 100 m. The first circuit is therefore good for access authorization control.

The second circuit with the NFC interface is capable of communicating by means of the NFC transmission standard with authenticating entities at distances of up to 10 cm. The second circuit is therefore good for driver authorization control because it is possible to discretely locate the key in the vehicle.

The implemented transmission standards also enable communication options with entities outside of the key, for other purposes.

The first circuit of a key according to the invention can have a first integrated circuit. The first integrated circuit can have means for the generation of a high-frequency signal, particularly with a 2.4 GHz carrier frequency. The first integrated circuit can further have means for the encryption and decryption of signals according to an AES algorithm. As such, a particularly strong encryption is possible.

The first integrated circuit can have a microcontroller. The μC can be a part of the first integrated circuit.

The first circuit can have one or more switches, particularly buttons. The key can thereby have a remote radio operation function. By way of example, notifications can be output to the microcontroller via the switch.

The first circuit can have an antenna which is suitable and constructed for transmitting and receiving signals according to the BTLE transmission standard.

The first circuit can have an energy storage device, particularly battery.

The first circuit can have a storage device. This can be included as a separate component, for example as an EEPROM, or as a storage device which is integrated into the first integrated circuit. The storage device can serve to store a digital key required for the AES algorithm.

The second circuit of a key according to the invention can have a second integrated circuit. The second integrated circuit can have means for the generation of a signal with a carrier frequency between 12 and 15 MHz, particularly with a 13.56 MHz carrier frequency. The second integrated circuit can further have means for the encryption and decryption of signals according to an AES algorithm.

The second circuit can also have a storage device. This can be included as a separate component, for example as an EEPROM, or as a storage device which is integrated into the second integrated circuit. The storage device can serve to store a digital key required for the AES algorithm.

The second circuit can have an induction coil via which electrical energy can be transmitted into the second circuit, and via which the communication is realized according to the NFC transmission standard.

In a particularly advantageous embodiment of the key according to the invention, the first integrated circuit and the second integrated circuit are united into one integrated circuit.

All electronic components of the key can be arranged on a molded interconnect device.

An arrangement according to the invention has at least one key according to the invention, and a motor vehicle, wherein the motor vehicle has at least one authenticating entity which has a BTLE interface and/or an NFC interface for the purpose of communication. The vehicle advantageously has an authenticating entity which is suitable and designed for communication with a BTLE interface, and has an authenticating entity which is suitable and designed for communication with an NFC interface.

These aspects are merely illustrative of the innumerable aspects associated with the present invention and should not be deemed as limiting in any manner. These and other aspects, features and advantages of the present invention will become apparent from the following detailed description when taken in conjunction with the referenced drawings.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 Shows a schematic illustration of a key according to the invention

### DETAILED DESCRIPTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

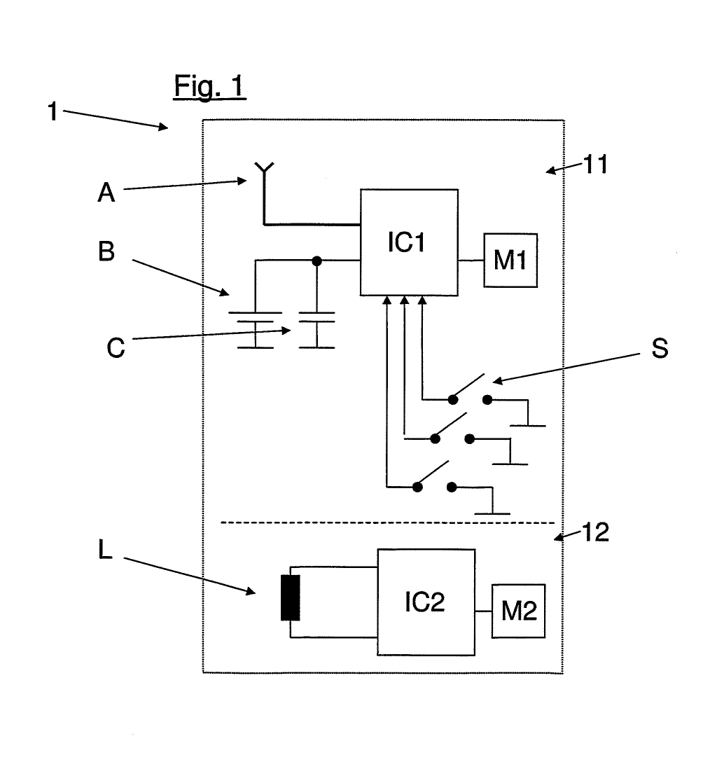

The key 1 shown schematically in FIG. 1 has a first circuit 11 and a second circuit 12.

The first circuit 11 has an integrated circuit IC1. The integrated circuit IC1 is connected to a battery B and a capacitor arranged parallel thereto. The battery B ensures a power supply to the first circuit 11.

In addition, a non-volatile storage device Ml is connected to the integrated circuit IC1 of the first circuit 11. A user can influence the first circuit 11 by means of the switches S.

Communication between the first circuit 11 of the key 1 and an authenticating entity outside of the key, for example in a motor vehicle, is possible by means of an antenna A. The communication corresponds to a BTLE standard.

The second circuit 12 likewise has an integrated circuit IC2. This is connected to a coil L which enables an inductive coupling of the second circuit to a receiver, both for the purpose of communication and the supply of power. The communication can occur with an authenticating entity, for example in a motor vehicle.

In addition, the second circuit 12 likewise has a non-volatile storage device M2.

The communication between the second circuit and the authenticating entity is realized according to the NFC standard.

The communication between the circuits 11, 12 of the key and the one or more authenticating entities occurs in encrypted form, and particularly according to an AES algorithm. The digital keys required for this communication are stored in the storage devices M1, M2.

Several examples are sketched below to show an advantageous use of the key according to the invention:

### EXAMPLE 1

Access authorization control by means of the first circuit

By actuating a switch of the first circuit, a motor vehicle is locked or unlocked according to the access authorization control—meaning according to a communication based on the BTLE standard, between the key and the vehicle.

### EXAMPLE 2

Access authorization control by means of the second circuit

By bringing the key into close proximity with an induction coil on board the vehicle, a communication is established between the key and an authenticating entity in the vehicle, leading to a locking or unlocking of the vehicle without a button being pressed.

### EXAMPLE 3

Driver authorization control by means of the second circuit

The key is brought [near] to an induction coil, for example in the region of the steering column. Communication is established with an authenticating entity in the vehicle. The authenticating entity then functions to allow the vehicle to start.

### EXAMPLE 4

Obtaining vehicle information by means of the second circuit

In a store, the user would like to know which motor oil is suitable for his or her vehicle. For this purpose, he or she holds the key near a suitable electronic device, for example a radio device, which then displays information about the motor vehicle stored in the key via the second circuit—for example, information on the suitable motor oil.

### EXAMPLE 5

Mobility assistance via the second circuit

The motor vehicle fails to operate, and the manufacturer of the motor vehicle must provide transport for the user due to a roadside assistance warranty for the user. The user informs the manufacturer of the situation covered by the warranty. The manufacturer informs a provider of transportation services (railroad companies, taxi companies, airlines, rental car companies, . . . ) that the user with the key of the inoperable motor vehicle is granted authorization to use the transportation services with costs carried by the manufacturer. The user of the motor vehicle can then electronically identify himself or herself to the transportation service provider as the person authorized to use the transportation services.

### EXAMPLE 6

Finding a parking space by means of the first circuit

A user parks his or her motor vehicle in a large parking lot garage. He or she locks the motor vehicle by means of the key according to the invention. At the moment when the doors are locked, or at the moment when the ignition is switched off, the motor vehicle transmits the current GPS coordinates to the key via BTLE. The data is saved in the key. Later, the user can display the GPS coordinates of the motor vehicle via his or her mobile telephone, the same being likewise equipped with a BTLE interface. This can simplify a search for the vehicle. In this case, it is helpful if the position of the motor vehicle is displayed on a map and/or the user is guided to the parking space of the motor vehicle.

The preferred embodiments of the invention have been described above to explain the Principles of the invention and its practical application to thereby enable others skilled in the art to utilize the invention in the best mode known to the inventors. However, as various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by the above-described exemplary embodiment, but should be defined only in accordance with the following claims appended hereto and their equivalents.

### LIST OF REFERENCES

1 key

11 first circuit

IC1 integrated circuit of the first circuit

B battery

C capacitor

M1 storage device

S switch

12 second circuit

IC2 integrated circuit of the second circuit

L coil

M2 storage device

1. A key with remote radio operation, comprises:
a housing;
first and second electronic circuits arranged in said housing operable for authentication of said key, wherein each of said first and second circuits is provided with an interface for communication with an authenticating entity outside of said key,
said first circuit further comprising a BTLE interface for communication; and
said second circuit further comprising an NFC interface for communication.

2. The key according to claim 1, wherein said first circuit further comprises a first integrated circuit.

3. The key according to claim 2, wherein said first integrated circuit further comprises a high-frequency signal generator.

4. The key according to claim 1, wherein said first integrated circuit further comprises a signal encryption/decryption device incorporating an AES algorithm.

5. The key according claim 1, wherein said first circuit further comprises at least one switch.

6. The key according to claim 1, wherein said first circuit further comprises a storage device.

7. The key according to claim 1, wherein said second circuit further comprises a second integrated circuit.

8. The key according to claim 7, wherein said second integrated circuit further comprises a signal generator is operable for producing a carrier frequency between 12 and 15 MHz.

9. The key according to claim 7, wherein said second integrated circuit further comprises a signal encryption/decryption device incorporating to an AES algorithm.

10. A motor vehicle and key arrangement, comprising:
at least one authenticating entity associated with said motor vehicle, said authenticating entity further comprising at least one of a BTLE interface and a NDF interface;
wherein said key comprises a housing;
first and second electronic circuits arranged in said housing operable for authentication of said key, wherein each of said first and second circuits is provided with an interface for communication with an authenticating entity outside of said key,
said first circuit further comprising a BTLE interface for communication; and
said second circuit further comprising an NFC interface for communication.

11. The key according to claim 3, wherein said high-frequency signal generator produces a 2.4 GHz carrier frequency.

12. The key according to claim 8, wherein said signal generator is operable for producing a 13.56 MHz carrier frequency.
